(19) United States
(12) Patent Application Publication
(10) Pub. No.: US 2025/0371408 A1
(43) Pub. Date: Dec. 4, 2025

(54) ADAPTATION OF COMPUTER-IMPLEMENTED MODELS USING ADAPTATION FUSION MATRICES

(71) Applicant: Dell Products L.P., Round Rock, TX (US)

(72) Inventors: MIN GONG, Shanghai (CN); DEEPAGANESH PAULRAJ, Bangalore (IN); ASHOK NARAYANAN POTTI, Bangalore (IN); DALE WANG, Hayward, CA (US)

(21) Appl. No.: 18/678,446

(22) Filed: May 30, 2024

(51) Int. Cl. G06N 20/00

(52) U.S. Cl. CPC G06N 20/00

(57) ABSTRACT

Methods and systems for managing computer-implemented models are disclosed. In particular, existing computer-implemented models (e.g., pre-trained models) may be tailored and adapted to fit the various requirements of an entity using a combination of adapter tuning, adapter fusion, and an adaptation group matrix. Such pre-trained models may be tuned using the adaptation group matrix to obtain one or more adaptation-group-tuned models. The adaptation group matrix may be continuously updated based on changes to the various requirements. Changes to the adaptation group matrix may cause the one or more adaptation-group-tuned models to be updated.

### FIELD

Embodiments disclosed herein relate generally to management of models (namely, computer-implemented models such as artificial intelligence/machine learning (AI/ML) based models). More particularly, embodiments disclosed herein relate to systems and methods to efficiently adapt models for various requirements of an entity.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with one or more embodiments disclosed herein.

FIG. 2A shows data flow diagrams in accordance with one or more embodiments disclosed herein.

FIGS. 2B-2F show implementation examples in accordance with one or more embodiments disclosed herein.

FIGS. 3A-3C show flow diagrams in accordance with one or more embodiments disclosed herein.

FIG. 4 shows a block diagram illustrating a data processing system in accordance with one or more embodiments disclosed herein.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing computer-implemented models. Such computer-implemented models may include artificial intelligence/machine learning (AI/ML) based models such as large language models (LLMs) (e.g., Generative Pre-Trained Transformers 3 (GPT-3), GPT-2, or the like), generative AI models, or the like.

In particular, entities (e.g., a user, a business, a corporation, an enterprise, or the like) face various challenges when tailoring (e.g., adapting) such computer-implemented models to various datasets and tasks (herein collectively referred to as “requirements” of an entity), requiring such models to accurately and cost-efficiently (e.g., monetary and non-monetary costs) respond to the entities' custom data.

For example, an entity may already have a pre-trained LLM that is specifically trained and tuned for a single specific task (e.g., text generation for the sales department of the entity, or the like). However, other departments (e.g., marketing, research and development (R&D), technical support, or the like) may also need text generation services (as an example of computer-implemented services provided by the LLM). These departments may also need the LLM to provide computer-implemented services (e.g., inference and/or prediction generation, or the like) for other tasks besides text generation (e.g., code generation, triage, question and answer (Q&A), or the like).

Adapting the single pre-trained LLM that this entity has to all of these requirements may not only negatively affect the already pre-trained LLM's accuracy, but may also cost the entity a large sum in both monetary (e.g., cash) and non-monetary (e.g., limited computing resources of the entity's computing devices) resources. In particular, significant amounts of limited computing resources (e.g., of the entity's computing devices) may be wasted on the re-training, maintenance, and inference generation of each new LLM (that is adapted from the single pre-trained LLM or newly generated) for each of the other requirements of the entity beside the specific task for which the single pre-trained LLM was originally designed.

These costs (e.g., monetary and non-monetary costs) may be broken down into: initial fine-tuning costs associated with initial model deployment or substantial updates to the model; maintenance costs associated with continuous data collection and annotation and re-fine tuning of the model; and inference costs associated with the computer-implemented services provided by the model whenever the model is utilized (e.g., storing of the models, configuration of run-time environments for each model, real-time support for each model, or the like). Each of these stages may use up limited computing resources of the entity's computing devices that may be needed for other services and/or uses, resulting in a decrease in the computer functionalities of these computing devices (e.g., other processes executed by these computing devices may become slower because more computing resources are being allocated to the adaptation of the models (e.g., LLM models).

To overcome the above-discussed challenges that these entities are facing, the computer-implemented model management process of one or more embodiments disclosed herein combine the use of adapter tuning (e.g., a specific type of model tuning technique), adapter fusion (e.g., another specific type of model tuning technique), and model adaptation matrices to allow entities to more efficiently tailor (e.g., adapt) existing models owned by the entities to fit the various requirements of the entities.

In particular, rather than tailoring (e.g., adapting) an existing model (e.g., an LLM) to ten (10) individual requirements of an entity, the ten individual requirements may be grouped into one or more adaptation groups. Assume here that the ten individual requirements are now grouped into two different adaptation groups, the existing model will now only need to be tailored (e.g., adapted) to these two groups. As a result, only two (rather than ten) new models will need to be trained, maintained, and stored.

Thus, an improved system may be obtained where existing models (e.g., pre-trained models) can be more efficiently tailored (e.g., adapted) to fit the various requirements of an entity. Limited computing resources of the system (e.g., made up of part of all of an entity's computing devices) may also advantageously be saved, which directly improves the functionality (e.g., computer functionalities) of the system itself (e.g., other processes besides model training, maintenance, and storage will no longer be negatively impacted).

In an embodiment, a computer-implemented method for managing computer-implemented models is provided. The method may include: obtaining one or more requirements of an entity and a pre-trained model, wherein the pre-trained model is not trained to provide computer implemented services associated with the one or more requirements when obtained; adapting the pre-trained model to a group of the one or more requirements to obtain an adaptation-group-tuned model; and using the adaptation-group-tuned model to provide computer implemented services associated with the group of the one or more requirements to the entity.

Adapting the pre-trained model to the group of the one or more requirements may include: obtaining, using the one or more requirements, a model adaptation candidate matrix comprising one or more model adaptation candidates; and grouping the one or more model adaptation candidates into one or more adaptation groups to obtain an adaptation group matrix, wherein each of the one or more adaptation groups is one instance of the group of the one or more requirements, wherein the pre-trained model is adapted to each of the one or more adaptation groups to obtain one or more adaptation-group-tuned models, the adaptation-group-tuned model being one of the one or more adaptation-group-tuned models.

The pre-trained model is adapted to each of the one or more adaptation groups using adapter fusion.

Each of the one or more adaptation groups comprises one or more adaptation layers for the pre-trained model, and the adapter fusion fuses the one or more adaptation layers into a fused-adaptation layer that is inserted into a component of the pre-trained model.

Each of the one or more adaptation layers is generated by performing adapter tuning on the pre-trained model.

The pre-trained model is a large language model (LLM), and the fused-adaptation layer is inserted into the LLM as a new parameter layer within existing parameter layers making up the LLM.

The method may further include: storing each of the one or more adaptation-group-tuned models into an adaptation-group-tuned model repository.

The method may further include: obtaining an update to the one or more requirements; and updating, using the update to the one or more requirements, the one or more adaptation groups in the adaptation group matrix to obtain an updated adaptation group matrix comprising one or more updated adaptation groups.

The method may further include: updating the one or more adaptation-group-tuned models stored in the adaptation-group-tuned model repository using the one or more updated adaptation groups and an adapter fusion technique.

Updating the one or more adaptation groups using the update to the one or more requirements may include at least one of: updating properties of one or more adapters making up an adaptation group of the one or more adaptation groups without adding a new adapter to the adaptation group or removing any of the one or more adapters, adding the new adapter to the adaptation group or removing any of the one or more adapters, or adding a new adapter group or removing at least one existing one of the one or more adaptation groups from the adaptation group matrix.

A non-transitory media may include instructions that when executed by a processor cause the computer-implemented method to be performed.

A data processing system (e.g., a model adaptation manager) may include the non-transitory media and a processor, and may perform the computer-implemented method when the computer instructions are executed by the processor.

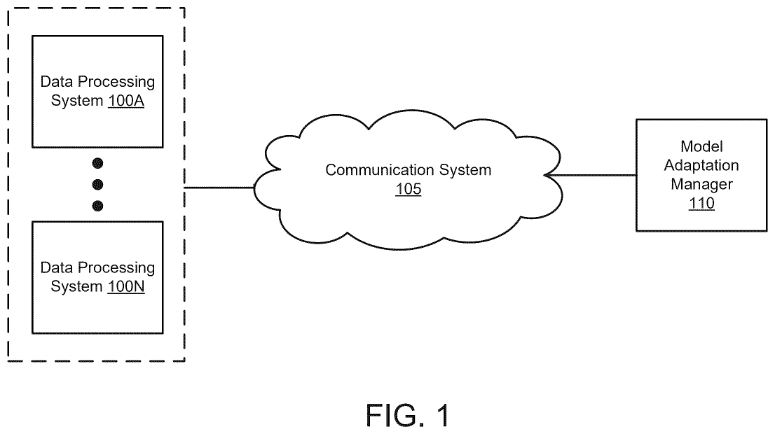

Turning to FIG. 1, a block diagram illustrating a system in accordance with an embodiment is shown. The system shown in FIG. 1 may provide computer-implemented services and may be managed by a model adaptation manager 110 in order to provide the computer-implemented services. The system may include data processing systems 100A-100N. Data processing systems 100A-100N may include any number of computing devices that provide the computer-implemented services. For example, data processing systems 100A-100N may include one or more computing devices that may independently and/or cooperatively provide the computer-implemented services. For example, all, or a portion, of data processing systems 100A-100N may provide computer-implemented services to users and/or other computing devices operably connected to data processing systems 100A-100N.

The computer-implemented services may include any type and quantity of services including, for example, database services, instant messaging services, video conferencing services, prediction and/or inference generation services, machine learning (ML)/artificial intelligence (AI) related services, data science related services, etc. Different systems may provide similar and/or different computer-implemented services. To provide the computer-implemented services, data processing systems 100A-100N may host applications and/or computer-implemented models (e.g., LLMs, generative AI models, or the like) that provide these (and/or other) computer-implemented services. The applications and/or computer-implemented models may be hosted by one or more of data processing systems 100A-100N. For example, the applications may utilize (e.g., invoke use of, or the like) one or more backend components (e.g., the computer-implemented models, policies, backend applications, data and infrastructures, or the like) to provide the computer-implemented services.

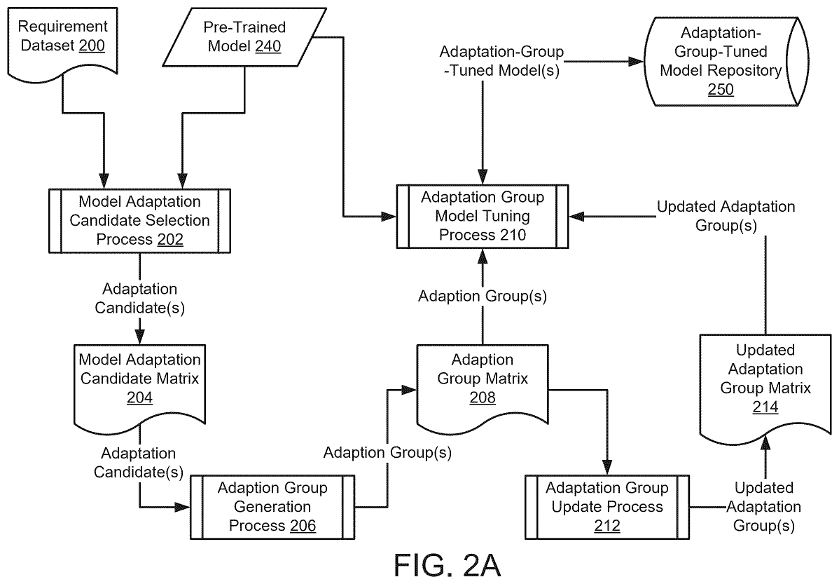

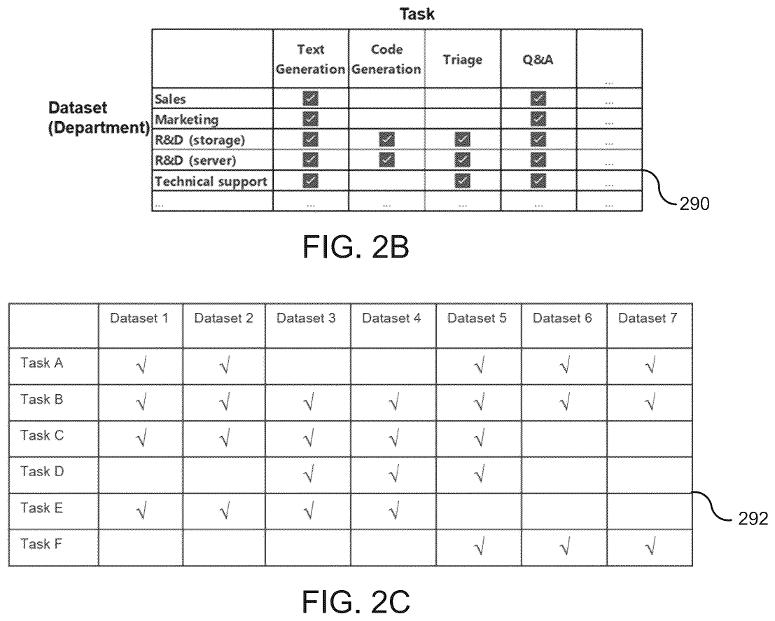

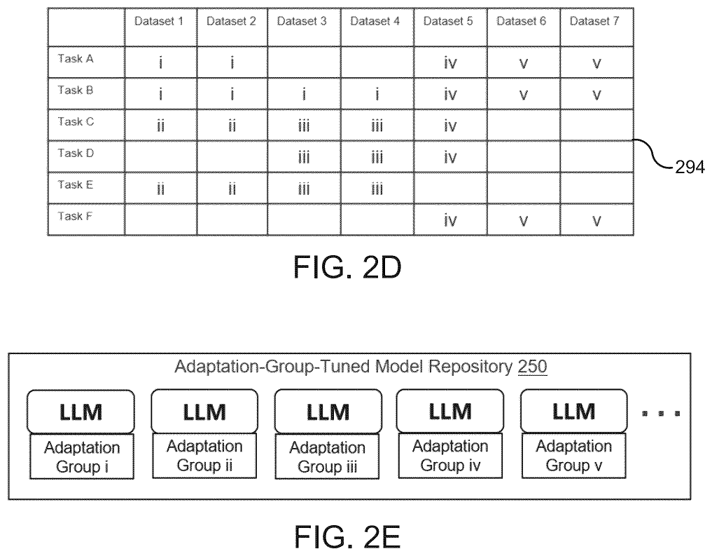

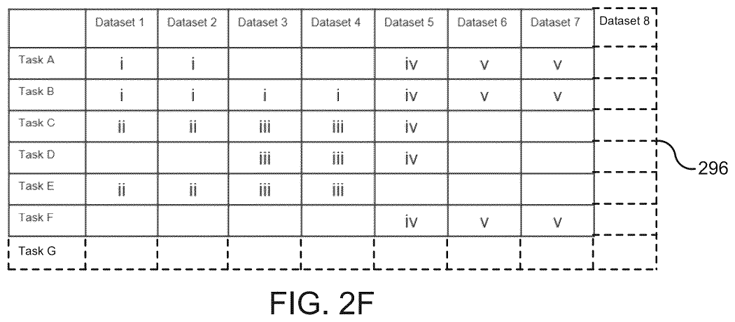

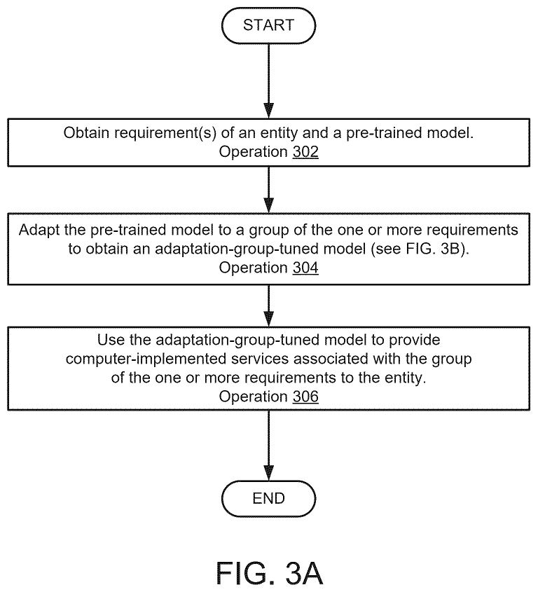

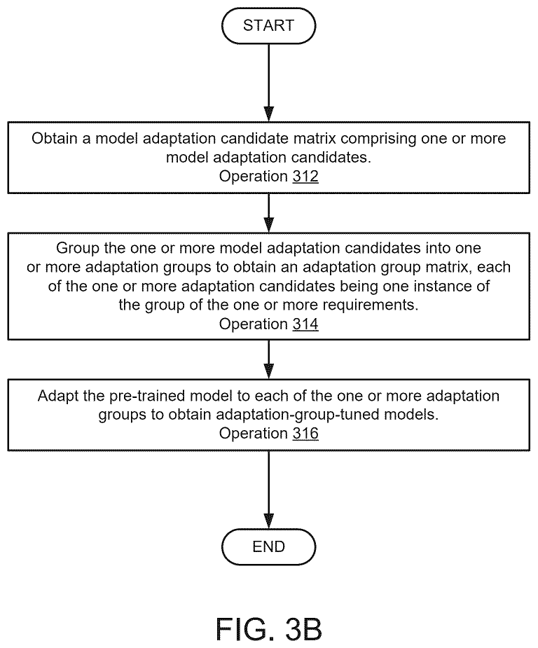

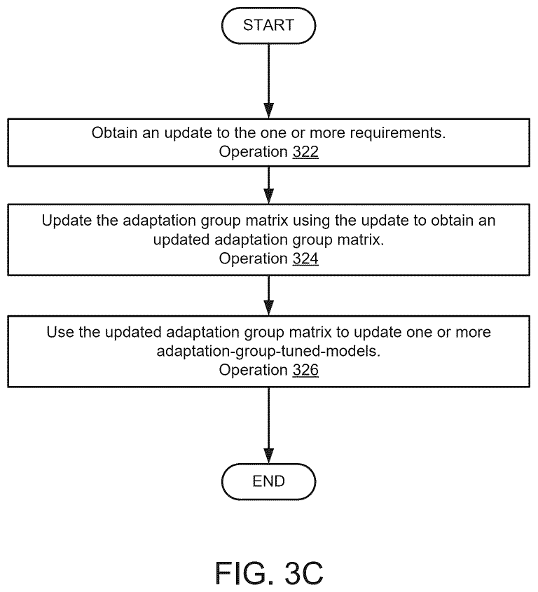

To manage and adapt these computer-implemented models that are being hosted (e.g., maintained and executed) by data processing systems 100A-100N, the system of FIG. 1 may include a model adaptation manager 110. In particular, the model adaptation manager 110 may be configured to perform (e.g., execute) a portion or all of the processes of one or more embodiments disclosed below in reference to FIGS. 2A-3C.

For example, model adaptation manager 110 may be configured to tailor and adapt existing computer-implemented models (e.g., pre-trained models) hosted by data processing systems 100A-100N to fit the various requirements of an entity using a combination of adapter tuning, adapter fusion, and an adaptation group matrix. Such pre-trained models may be tuned using the adaptation group matrix to obtain one or more adaptation-group-tuned models. The adaptation group matrix may be continuously updated based on changes to the various requirements. Changes to the adaptation group matrix may cause the one or more adaptation-group-tuned models to be updated.

In particular, instead of adapting a pre-trained model to all of the entity's requirements individually, the entity's requirements may be analyzed and grouped into adaptation groups. These adaptation groups may be stored in the adaptation group matrix. Thus, rather than tailoring (e.g., adapting) an existing model (e.g., an LLM) to, for example, ten (10) individual requirements of an entity, the ten individual requirements may be grouped into one or more of the adaptation groups. Assume here that the ten individual requirements are now grouped into two different adaptation groups, the existing pre-trained model will now only need to be tailored (e.g., adapted) to these two groups. As a result, only two (rather than ten) new models will need to be trained, maintained, and stored.

As a result, monetary and non-monetary costs (e.g., initial fine-tuning costs associated with initial model deployment or substantial updates to the model; maintenance costs associated with continuous data collection and annotation and re-fine tuning of the model; and inference costs associated with the computer-implemented services provided by the model whenever the model is utilized (e.g., storing of the models, configuration of run-time environments for each model, real-time support for each model, or the like)) associated with adapting the pre-trained model to fit all of the entity's requirements may be more efficiently allocated and utilized.

Thus, an improved system may be obtained where the pre-trained model can be more efficiently tailored (e.g., adapted) to fit the various requirements of an entity. Limited computing resources of the system (e.g., made up of part of all of the data processing systems 100A-100N) may also advantageously be saved, which directly improves the functionality (e.g., computer functionalities) of the system itself. For example, each stage (e.g., initial fine-tuning, maintenance, and inference generation) associated with the adaptation of the pre-trained model to new requirements may use up limited computing resources of the entity's computing devices that may be needed for other services, processes, and/or uses, resulting in a decrease in the computer functionalities of these computing devices (e.g., other processes executed by these computing devices may become slower because more computing resources are being allocated to the adaptation of the models (e.g., LLM models). By saving limited computer resources required for model adaptation, the functionalities of the system may be improved to better provide such other services, processes, and/or uses.

Furthermore, when providing their functionality, data processing systems 100A-100N and/or model adaptation manager 110 may perform all, or a portion, of the method and/or actions shown in FIGS. 2A-3C.

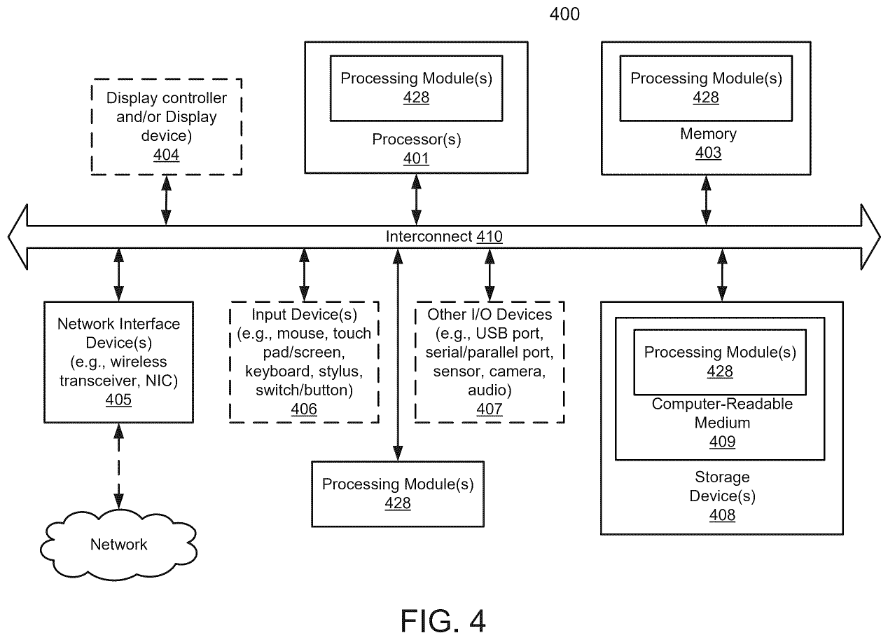

Data processing systems 100A-100N and model adaptation manager 110 may be implemented using a computing device such as a host or server, a personal computer (e.g., desktops, laptops, and tablets), a “thin” client, a personal digital assistant (PDA), a Web enabled appliance, or a mobile phone (e.g., Smartphone), an embedded system, local controllers, and/or any other type of data processing device or system. For additional details regarding computing devices, refer to FIG. 4.

Any of the components illustrated in FIG. 1 may be operably connected to each other (and/or components not illustrated) with a communication system 105. In an embodiment, communication system 105 may include one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as included a limited number of specific components, a system in accordance with an embodiment may include fewer, additional, and/or different components than those illustrated therein.

To further clarify embodiments disclosed herein, a data flow diagram in accordance with an embodiment are shown in FIG. 2A. In this diagram, flows of data and processing of data are illustrated using different sets of shapes. A first set of shapes (e.g., 200, 204, 208, 214, etc.) is used to represent data structures, a second set of shapes (e.g., 202, 206, 210, etc.) is used to represent processes performed using and/or that generate data, a third set of shapes (e.g., 250, etc.) is used to represent large scale data structures such as databases, and a fourth set of shapes (e.g., 240) is used to represent the computer-implemented models.

Additionally, the data flow diagram of FIG. 2A will be discussed in combination with implementation examples of embodiments disclosed herein shown in FIGS. 2B-2F. None of the implementation examples are intended to limit the scope of embodiments disclosed herein. Other forms, formats, or the like of the implementation examples may be used without departing from the scope of embodiments disclosed herein.

As shown in FIG. 2A, a data flow diagram illustrating a computer-implemented model adaptation process of embodiments disclosed herein is provided. Initially, a requirement dataset 200 and a pre-trained model 240 may be obtained. Although only a single of each component is shown in FIG. 2A, any number of the requirement dataset 200 and the pre-trained model 240 may be obtained without departing from embodiments disclosed herein.

In embodiments, the pre-trained model 240 may be an existing computer-implemented model (e.g., an LLM, a generative AI model, or the like) that is hosted by one or more data processing systems (e.g., data processing systems 100A-100N). This pre-trained model 240 may be configured to provide specific computer-implemented services directed to one or more specific requirements of an entity. For example, assume that the entity is an enterprise, business, or corporation having various departments (e.g., sales, marketing, research and development (R&D), technical support, or the like) that each perform various tasks (e.g., text generation, code generation, triage, question and answer (Q&A), or the like), the pre-trained model 240 may, for example, be specifically configured to provide text generation for the sales department. Said another way, in this example, the pre-trained model 240 can only provide text generation related computer-implemented services for the needs of the sales department and is not configured (e.g., trained) to do any of the other tasks for any of the other departments (including any non-code generation tasks for the sales department).

In embodiments, the requirement dataset 200 may include information regarding the requirements of the entity. These requirements may be broken down, for example, into the tasks and departments of the entity. An example requirement dataset 290 is shown is shown in FIG. 2B. As shown in FIG. 2B, the example requirement dataset 290 indicates all of the existing datasets (as categorized by departments) that an entity in relation to one or more tasks associated with each dataset. For example, example requirement dataset 290 shows that an entity has a dataset for sales that is used for text generation purposes (where the checkmark icon indicates that such dataset exists for a specific task).

Each of these combinations shown in example requirement dataset 290 of FIG. 2B may require a separately trained computer-implemented model. Said another way, the pre-trained model 240 may need to be adapted for each of the combinations shown in example requirement dataset 290 of FIG. 2B.

In embodiments, the requirements in a requirement dataset 200 may be broken down into other parameters and/or specification (besides task and dataset) without departing from embodiments disclosed herein.

Turning back to FIG. 2A, the requirement dataset 200 and information regarding the pre-trained model 240 may be ingested into model adaptation candidate selection process 202. Information regarding the pre-trained model 240 may include any and all information making up each the pre-trained model 240. For example, if the pre-trained model 240 is an LLM, this information may include, but is not limited to: all of the parameter layers making up the LLM; all of the code (e.g., computer-implemented code) making up the LLM; information on all of the data processing systems that are hosting the LLM; the dataset(s) used to train the LLM; or the like. Any and all information that is able to give a user of the entity a comprehensive understanding of the pre-trained model 240 may be included without departing from the scope of embodiments disclosed herein.

The model adaptation candidate selection process 202 is configured to generate one or more adaptation candidates using the requirement dataset 200 and information regarding the pre-trained model 240. Each of the adaptation candidates may correspond to one or more adaptation layers (e.g., generated using adapter tuning for LLMs) generated to tailor (e.g., adapt) an existing computer-implemented model (e.g., pre-trained model 240) to provide new computer-implemented services that it previously was not trained to provide. These adaptation candidates generated by model adaptation candidate selection process 202 may be stored in a model adaptation candidate matrix 204 generated by the model adaptation candidate selection process 202.

In embodiments, the model adaptation candidate selection process 202 may use pre-defined parameters, statistics, policies and rules (e.g., stakeholder-based decision based on business or usage statistics, or the like), or the like of the entity to determine which task-dataset combination in requirement dataset 200 is a valid combination that will require a separate (e.g., a tailored and/or adapted version of the pre-trained model) computer-implemented model. For example, referring to the example requirement dataset 290 of FIG. 2B, the entity may have enough usage of the code generation-R&D (storage) combination that a separate computer-implemented model is required for this requirement.

An example model adaptation candidate matrix 292 is shown in FIG. 2C. As shown in FIG. 2C, each cell of the example model adaptation candidate matrix 292 that includes a checkmark indicates a valid dataset-task combination for an adaptation layer to be generated to adapt an exiting model (e.g., pre-trained model 240) to provide new computer-implemented services associated with that dataset-task combination.

For example, assume that dataset 1 is a marketing dataset and task A is a Q&A task (in reference to the data shown in example requirement dataset 290 of FIG. 2B). Further assume, as discussed in the above example, that pre-trained model 240 is configured (e.g., trained) specifically for only text generation based on sales datasets. Because of the checkmark included in the dataset 1-task A combination box, model adaptation candidate selection process 202 has determined that an adaptation layer is required to be generated to tailor (e.g., adapt) pre-trained model 240 to perform computer-implemented services associated with Q&A based on the marketing dataset. Thus, as shown in FIG. C, the example model adaptation candidate matrix 292 shows twenty-seven (27) valid requirements (e.g., adaptation candidates) that require adaptation layer generation (e.g., using adapter tuning) for adapting the pre-trained model 240 to provide computer-implemented services directed to these requirements. Said another way, the example model adaptation candidate matrix 292 indicates that twenty-seven (27) new models (adapted from pre-trained model 240) will be required to be trained to provide services to meet all of the entity's requirements.

In the context of one or more embodiments, the term “adapter tuning” refers to a specific technique for adapting existing LLMs to provide new/updated services. This specific technique of “adapter turning” generates adapter layers (herein also referred to as “adapters”) that are inserted between existing parameters of an LLM to tailor (e.g., adapt) the LLM to provide new/updated services. Only the parameters of these adapter layers are tuned while no changes (e.g., tuning) are implemented to any of the existing portions of the LLM.

Turning back now to FIG. 2A, the model adaptation candidate matrix 204 generated using the model adaptation candidate selection process 202 is provided to an adaptation group generation process 206.

In embodiments, the adaptation group generation process 206 to analyze all of the adaptation candidates included in the model adaptation candidate matrix 204 to determine which of the model adaptation candidates may be grouped into one or more adaptation groups. For example, the following process may be used (in the context of the task-department example shown in FIGS. 2B and 2C) by the adaptation group generation process 206 to determine the adaptation groups:

Step 1—A data similarity analysis step that includes: (i) comparing features and characteristics of different datasets across departments; (ii) identifying commonalities (e.g., shared data types, structures, themes, or the like) between the different datasets; (iii) assessing a degree of overlap in the different datasets; or the like.

Step 2—A task redundancy evaluation step that includes: (i) examining the nature of tasks undertaken by different departments; (ii) identifying recurring patterns or themes in the task requirements; (iii) assessing the level of redundancy in tasks performed by multiple departments; or the like.

Step 3—A clustering and group formation step that includes: (i) employing clustering algorithm(s) or similarity thresholds to group together datasets and tasks with high similarity; (ii) identifying clusters that exhibit redundancy or shared characteristics, forming the basis for the adaptation groups (also referred to herein as “adapter groups”); (iii) ensuring that each adaptation group encompasses a set of dataset-task combinations that demonstrates substantial similarity or redundancy; or the like.

Any techniques that can be used to make such assessments discussed in Steps 1-3 may be used without departing from the scope of embodiments disclosed herein. Different combinations of these Steps (e.g., any combination or all of removing a Step, adding a new Step, repeating a Step, different ordering of the Steps, or the like) may also be used without departing from the scope of embodiments disclosed herein. Other grouping techniques, methods, processes, or the like (different from those illustrated in the above Steps) may also be used to generate the adaptation groups without departing from the scope of embodiments disclosed herein.

Once all of the adaptation group(s) are identified, the adaptation group generation process 206 generates an adaptation group matrix 208 to store the adaptation group(s). An example adaptation group matrix 294 generated based on the example model adaptation candidate matrix 292 of FIG. 2C is shown in FIG. 2D. In particular, as shown in FIG. 2D, five groups of adaptation groups were identified (e.g., as shown using roman numerals i through v). Each of the adaptation groups (e.g., Group i, Group ii, Group iii, Group iv, and Group v) is shown to include more than one of the adaptation candidates shown in the example model adaptation candidate matrix 292 of FIG. 2C. Each adaptation group includes adapter candidates that are determined to be able to share a same fine-tuned model (e.g., an adapted version of the pre-trained model 240). As a result, as shown in the example adaptation group matrix 294 of FIG. 2D, only five (5) new models (e.g., new models adapted from pre-trained model 240) are required instead of the original twenty-seven (27) shown in FIG. 2C.

Turning back to FIG. 2A, the adaptation group matrix 208 (e.g., generated by the adaptation group generation process 206) is provided to an adaptation group model tuning process 210. In embodiments, the pre-trained model 240 is also provided to the adaptation group model tuning process 210 as the base (e.g., original) model that will be tailored (e.g., adapted) into new models for providing new/updated computer-implemented services for the various other requirements of the entity.

In embodiments, adaptation group model tuning process 210 is configured to use one or more techniques to fuse the adaptation candidates in an adaptation group into a single adaptation fusion component (e.g., the above-discussed adapter/adaptation layer using in adapter tuning) for tailoring (e.g., adapting) an instance (e.g., a copy) of the pre-trained model 240 for that adaptation group.

For example, in the context of an LLM model and using adapter tuning, adapter fusion may be used to fuse the various adaptation candidates (e.g., adaptation layers/adapters) into a single adaptation layer/adapter (also referred to herein as a “fused-adaptation layer”. In the context of one or more embodiments, the term “adapter fusion” refers to specific AI/ML based technique associated with the adapter tuning method discussed above. Other techniques, methods, and/or processes that can be used to fuse the various adaptation candidates into a single adaptation layer/adapter (besides from adapter fusion) may also be used without departing from the scope of embodiments disclosed herein.

In embodiments, adaptation group model tuning process 210 may be configured to generate one adaptation-group-tuned model for each adaptation group included in the adaptation group matrix 208. Each of these adaptation-group-tuned model may be tailored (e.g., adapted, tuned, etc.) to provide computer-implemented services associated with the specific datasets and tasks that make up an adaptation group.

Once generated, the adaptation-group-tuned model(s) may be stored into an adaptation-group-tuned model repository 250 (e.g., a repository made up of storage space of one or more of the data processing systems 100A-100N, a repository made up of storage space of the model adaptation manager 110 of FIG. 1, a repository made up of storage space of a separate and distinct computing device that is remote to all of the data processing systems 100A-100N and the model adaptation manager 110 of FIG. 1, or the like). An example of the adaptation-group-tuned model repository 250 is shown in FIG. 2E.

In particular, as shown in FIG. 2E, the adaptation-group-tuned model repository 250 includes five (5) LLMs that are tuned for each of the five (5) adaptation groups shown in the example adaptation group matrix 294 of FIG. 2D. Each of these adaptation-group-tuned models are specifically tuned to provide computer-implemented services associated with only the requirements that make up each of the adaptation groups. Said another way, adaptation-group-tuned model for adaptation group “Group i” is not suitable for providing computer-implemented services associated with the requirements of any of the other groups (e.g., Groups ii to v), and so on. Each of the adaptation-group-tuned models shown in the adaptation-group-tuned model repository 250 may be used (e.g., via application programing interface (API) calls) by one or more applications to provide computer-implemented services.

Turning back to FIG. 2A, the requirements of an entity may continuously change (e.g., be updated, modified, or the like by the entity) over time. When such changes are detected (or notified to the system), the adaptation group matrix 208 may be updated via adaptation group update process 212 to generate an updated adaptation group matrix 214.

An example change to the requirements of the entity is shown in FIG. 2F. As shown in FIG. 2F, an updated matrix 296 is shown to include a new dataset (e.g., dataset 8) and a new task (e.g., task G). Other types of changes that do not include the addition of new datasets and task may also be received without departing from the scope of embodiments disclosed herein.

Turning back to FIG. 2A, the adaptation group update process 212 may be configured to: (i) determine the change(s) to the requirements; (iii) determine what changes to make to the adaptation group matrix 208 (e.g., including changes to the model adaptation candidate matrix 204); or the like.

In embodiments disclosed herein, changes may be categorized into three (3) separate categories: (i) local changes; (iii) accumulated local changes; and (iii) structural changes.

Local changes may include just an updated (e.g., fine-tuning, or the like) of one or more adapters. For example, a local change is determined to have occurred when the change(s) are limited to the update of a single adapter's dataset or a modification in the task without the change(s) affecting the similarity relationships between adapters (e.g., the change(s) do not affect the grouping of the current adaptation groups). In such a case, simply updating the corresponding adapter(s) (e.g., properties of the adapter(s)) (without having to update the adaptation fusion component generated using these adapters) would be sufficient.

Accumulated changes may include update(s) that would cause a change to the adaptation fusion component (e.g., the single adaptation layer/adapter fused using the adaptation candidates using adapter fusion). Accumulated changes may occur when multiple local changes have occurred (e.g., a predetermined number of local changes have been exceeded). Similar to local changes, the grouping of the current adaptation groups is not affected and remains the same.

Structural changes may include changes to the entire matrix (e.g., the model adaptation candidate matrix 204). For example, a structural change is determined to have occurred in the updated matrix 296 of FIG. 2F where the addition of new dataset(s) and/or task(s) results in the addition of new individual adaptation candidates. When such structural changes occur, the following steps may be implemented to update the adaptation group matrix 208:

Step 1—A similarity and redundancy assessment similar to any one or all of above-discussed Steps 1-3 performed by the adaptation group generation process 206 to group the adaptation candidates into the adaptation groups. For example, the new newly added adaptation candidates may be compared to the existing adaptation candidates using the processes (one or all) of above-discussed Steps 1-3 performed by the adaptation group generation process 206.

Step 2—An adapter fusion and new group creation step including: (i) based on the results of Step 1, determining whether to merge the new adaptation candidate(s) into an existing adaptation group, create a new adaptation group (or groups) with just the new adaptation candidate(s), or create entirely new adaptation groups having different combinations of the new and old adaptation candidates. Such a determination may be based on various factors (e.g., cost factors, limited computer resources usage factors, or the like) associated with one or more rules and/or policies of the entity. For example, such determination may be based on an optimization schema including: (i) a reward (profit) calculation including the potential reduction in inference costs (e.g., model implementation and usage costs) through model sharing); and (ii) a penalty (ii) calculation including determining the cost of adjusting an existing group's fusion component and the cost of re-fine-tuning one or more of the adaptation-group-tuned models (e.g., stored in the adaptation-group-tuned model repository 250) and/or another instance (e.g., copy) of the pre-trained model 240). Other types of schemas and/or criteria based on the different parts of a model's lifecycle (e.g., initial fine-tuning, maintenance, inference generation, or the like) may also be used without departing from the scope of embodiments disclosed herein.

The changes may be categorized into more or less than three (3) categories and each category may be defined differently (e.g., based on the rules and policies of the entity) without departing from the scope of embodiments disclosed herein. Other steps made up of different techniques, methods, or processes for updating the adaptation group matrix may also be used without departing from the scope of embodiments disclosed herein.

Turning back to FIG. 2A, once an updated adaptation group matrix 214 is generated by adaptation group update process 212, the updated adaptation group matrix 214 is provided to adaptation group model tuning process 210 where (i) new adaptation-group-tuned model(s) may be generated and/or (iii) existing adaptation-group-tuned model(s) may be updated based on the new information (e.g., data) included in the updated adaptation group matrix 214. The newly generated adaptation-group-tuned model(s) and/or updated existing adaptation-group-tuned model(s) may be stored back into the adaptation-group-tuned model repository, and be utilized (e.g., via application calls, or the like) to provide computer-implemented services associated with the updated requirements of the entity (e.g., the updated requirements that caused execution of adaptation group update process 212).

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Turning to FIGS. 3A-3C, flow diagrams illustrating methods for managing computer-implemented models in accordance with one or more embodiments are shown. The methods may be performed, for example, by any of the components of the system of FIG. 1, and/or other components not shown therein.

At operation 302, as discussed above in reference to FIGS. 2A and 2B, requirement(s) of an entity and a pre-trained model may be obtained (e.g., by model adaptation manager 110). In embodiments, the requirement(s) may be specified in one or more requirement datasets (e.g., requirement dataset 200 of FIG. 2A).

In embodiments, the pre-trained model (e.g., pre-trained model 240 of FIG. 2A) may not be configured (e.g., trained, fine-tuned, or the like) to provide computer implemented services associated with one, a group of, or all of the obtained requirement(s).

At operation 304, as discussed above in reference to FIGS. 2A and 2B-2E (namely, as parts of model adaptation candidate selection process 202, adaptation group generation process 206, and adaptation group model tuning process 210 of FIG. 2A), the pre-trained model may be adapted to a group of the one or more requirements to obtain an adaptation-group-tuned-model.

In particular, turning to FIG. 3B to discuss operation 304 of FIG. 3A in more detail, in operation 312 (of FIG. 3B) and as discussed above in reference to FIGS. 2A and 2C (namely, the details associated with model adaptation candidate selection process 202 of FIG. 2A), the requirement(s) and pre-trained model obtained in operation 302 of FIG. 3A may be used to obtain a model adaptation candidate matrix comprising one or more model adaptation candidates.

In operation 314, as discussed above in reference to FIGS. 2A and 2D (namely, the details associated with adaptation group generation process 206 of FIG. 2A), the one or more model adaptation candidates may be grouped into one or more adaptation groups to obtain an adaptation group matrix.

In embodiments, each of the one or more adaptation group candidates correspond to one instance of the group of the one or more requirements referenced in operation 304 of FIG. 3A.

In operation 316, as discussed above in reference to FIGS. 2A and 2E (namely, the details associated with adaptation group model tuning process 210 of FIG. 2A), instances (e.g., copies) of the pre-trained model may be adapted to each of the one or more adaptation groups to obtain adaptation-group-tuned models (one for each of the one or more adaptation groups).

In embodiments, the adaptation-group-tuned models may be stored in an adaptation-group-tuned model repository (e.g., adaptation-group-tuned model repository 250 of FIGS. 2A and 2E).

The process of FIG. 3B may end following operation 316.

Turning back to FIG. 3A, in operation 306 and as discussed above in reference to FIG. 2A, the adaptation-group-tuned model (obtained in operation 304) may be used (e.g., by applications via API calls) to provide computer-implemented services associated with the group of the one or more requirements to the entity.

The process of FIG. 3A may end following operation 306.

Turning now to FIG. 3C, at operation 322, as discussed above in reference to FIGS. 2A and 2F (namely, the details associated with adaptation group update process 212 of FIG. 2A), an update to the one or more requirements may be obtained. This update may be obtained at any time following the events of the method discussed above in FIG. 3A.

At operation 324, as discussed above in reference to FIG. 2A (namely, the details associated with adaptation group update process 212 of FIG. 2A), the adaptation group matrix (e.g., an existing adaptation group matrix) may be updated using the update to the one or more requirements to obtain an updated adaptation group matrix.

At operation 326, as discussed above in reference to FIG. 2A (namely, the details associated with adaptation group update process 212 of FIG. 2A), the updated adaptation group matrix may be used to update one or more adaptation-group-tuned-models stored in the adaptation-group-tuned-model repository. The updated adaptation group matrix may also be used to tailor (e.g., adapt) another instance (e.g., copy) of the pre-trained model into new adaptation-group-tuned-model(s).

The process of FIG. 3C may end following operation 326.

Any of the components illustrated in FIGS. 1-3C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations.

System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-408 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like.

More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets.

Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device.

For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing computer-implemented models, the method comprising:
obtaining one or more requirements of an entity and a pre-trained model, wherein the pre-trained model is not trained to provide computer implemented services associated with the one or more requirements when obtained;
adapting the pre-trained model to a group of the one or more requirements to obtain an adaptation-group-tuned model; and
using the adaptation-group-tuned model to provide computer implemented services associated with the group of the one or more requirements to the entity.

2. The method of claim 1, wherein adapting the pre-trained model to the group of the one or more requirements comprises:
obtaining, using the one or more requirements, a model adaptation candidate matrix comprising one or more model adaptation candidates; and
grouping the one or more model adaptation candidates into one or more adaptation groups to obtain an adaptation group matrix, wherein each of the one or more adaptation groups is one instance of the group of the one or more requirements,
wherein the pre-trained model is adapted to each of the one or more adaptation groups to obtain one or more adaptation-group-tuned models, the adaptation-group-tuned model being one of the one or more adaptation-group-tuned models.

3. The method of claim 2, wherein the pre-trained model is adapted to each of the one or more adaptation groups using adapter fusion.

4. The method of claim 3, wherein each of the one or more adaptation groups comprises one or more adaptation layers for the pre-trained model, and the adapter fusion fuses the one or more adaptation layers into a fused-adaptation layer that is inserted into a component of the pre-trained model.

5. The method of claim 4, wherein each of the one or more adaptation layers is generated by performing adapter tuning on the pre-trained model.

6. The method of claim 5, wherein the pre-trained model is a large language model (LLM), and the fused-adaptation layer is inserted into the LLM as a new parameter layer within existing parameter layers making up the LLM.

7. The method of claim 2, further comprising:
storing each of the one or more adaptation-group-tuned models into an adaptation-group-tuned model repository.

8. The method of claim 7, further comprising:
obtaining an update to the one or more requirements; and
updating, using the update to the one or more requirements, the one or more adaptation groups in the adaptation group matrix to obtain an updated adaptation group matrix comprising one or more updated adaptation groups.

9. The method of claim 8, further comprising:
updating the one or more adaptation-group-tuned models stored in the adaptation-group-tuned model repository using the one or more updated adaptation groups and an adapter fusion technique.

10. The method of claim 8, wherein updating the one or more adaptation groups using the update to the one or more requirements comprises at least one of:
updating properties of one or more adapters making up an adaptation group of the one or more adaptation groups without adding a new adapter to the adaptation group or removing any of the one or more adapters,
adding the new adapter to the adaptation group or removing any of the one or more adapters, or
adding a new adapter group or removing at least one existing one of the one or more adaptation groups from the adaptation group matrix.

11. A non-transitory machine-readable medium having instructions stored therein, which when executed by a processor, cause the processor to perform operations for managing computer-implemented models, the operations comprising:
obtaining one or more requirements of an entity and a pre-trained model, wherein the pre-trained model is not trained to provide computer implemented services associated with the one or more requirements when obtained;
adapting the pre-trained model to a group of the one or more requirements to obtain an adaptation-group-tuned model; and
using the adaptation-group-tuned model to provide computer implemented services associated with the group of the one or more requirements to the entity.

12. The non-transitory machine-readable medium of claim 11, wherein adapting the pre-trained model to the group of the one or more requirements comprises:
obtaining, using the one or more requirements, a model adaptation candidate matrix comprising one or more model adaptation candidates; and
grouping the one or more model adaptation candidates into one or more adaptation groups to obtain an adaptation group matrix, wherein each of the one or more adaptation groups is one instance of the group of the one or more requirements,
wherein the pre-trained model is adapted to each of the one or more adaptation groups to obtain one or more adaptation-group-tuned models, the adaptation-group-tuned model being one of the one or more adaptation-group-tuned models.

13. The non-transitory machine-readable medium of claim 12, wherein the pre-trained model is adapted to each of the one or more adaptation groups using adapter fusion.

14. The non-transitory machine-readable medium of claim 13, wherein each of the one or more adaptation groups comprises one or more adaptation layers for the pre-trained model, and the adapter fusion fuses the one or more adaptation layers into a fused-adaptation layer that is inserted into a component of the pre-trained model.

15. The non-transitory machine-readable medium of claim 14, wherein each of the one or more adaptation layers is generated by performing adapter tuning on the pre-trained model.

16. A model adaptation manager, comprising:
a processor; and
a memory coupled to the processor to store instructions, which when executed by the processor, cause the processor to perform operations for managing computer-implemented models, the operations comprising:
obtaining one or more requirements of an entity and a pre-trained model, wherein the pre-trained model is not trained to provide computer implemented services associated with the one or more requirements when obtained;
adapting the pre-trained model to a group of the one or more requirements to obtain an adaptation-group-tuned model; and
using the adaptation-group-tuned model to provide computer implemented services associated with the group of the one or more requirements to the entity.

17. The model adaptation manager of claim 16, wherein adapting the pre-trained model to the group of the one or more requirements comprises:
obtaining, using the one or more requirements, a model adaptation candidate matrix comprising one or more model adaptation candidates; and
grouping the one or more model adaptation candidates into one or more adaptation groups to obtain an adaptation group matrix, wherein each of the one or more adaptation groups is one instance of the group of the one or more requirements,
wherein the pre-trained model is adapted to each of the one or more adaptation groups to obtain one or more adaptation-group-tuned models, the adaptation-group-tuned model being one of the one or more adaptation-group-tuned models.

18. The model adaptation manager of claim 17, wherein the pre-trained model is adapted to each of the one or more adaptation groups using adapter fusion.

19. The model adaptation manager of claim 18, wherein each of the one or more adaptation groups comprises one or more adaptation layers for the pre-trained model, and the adapter fusion fuses the one or more adaptation layers into a fused-adaptation layer that is inserted into a component of the pre-trained model.

20. The model adaptation manager of claim 19, wherein each of the one or more adaptation layers is generated by performing adapter tuning on the pre-trained model.
